(19) United States
(12) Patent Application Publication
(10) Pub. No.: US 2012/0133322 A1
(43) Pub. Date: May 31, 2012

(54) SOLAR POWER MANAGEMENT FOR A VEHICLE

(75) Inventors: Kevin Walsh, Orange, CA (US); Paul Boskovitch, Costa Mesa, CA (US); Axel Radermacher, Foothill Ranch, CA (US)

(73) Assignee: Fisker Automotive, Inc.

(21) Appl. No.: 13/144,650

(22) PCT Filed: Jan. 15, 2010
(86) PCT No.: PCT/US10/21236

§ 371 Date: Feb. 14, 2012

Related U.S. Application Data
(60) Provisional application No. 61/144,976, filed on Jan. 15, 2009.

(51) Int. Cl. H02J 7/00

(52) U.S. Cl. 320/101

(57) ABSTRACT

A photovoltaic storage and charging system for a vehicle includes a photovoltaic apparatus disposed on the vehicle for absorbing radiant energy and converting the absorbed radiant energy into electrical energy. At least one energy storage device stores the electrical energy from the photovoltaic apparatus, and the stored electrical power is available for use by the vehicle. An electrical energy converter is disposed between the photovoltaic apparatus and the energy storage device, to receive the electrical energy from the photovoltaic apparatus, boost the energy to a predetermined level for charging the energy storage device and deliver the boosted electrical energy to the energy storage device.

### BACKGROUND

The present disclosure relates generally to a vehicle, and more particularly to a vehicle that utilizes solar power as an energy source and the management of the solar power distribution.

### DESCRIPTION OF THE RELATED ART

Vehicles, such as a motor vehicle, utilize an energy source in order to provide power to operate a vehicle. While petroleum based products dominate as an energy source, alternative energy sources are available, such as methanol, ethanol, natural gas, hydrogen, electricity, solar or the like. A hybrid powered vehicle utilizes a combination of energy sources in order to power the vehicle. Such vehicles are desirable since they take advantage of the benefits of multiple fuel sources, in order to enhance performance and range characteristics of the vehicle, as well as reduce environmental impact relative to a comparable gasoline powered vehicle.

An example of a hybrid vehicle is a vehicle that utilizes both electric and solar energy as power sources. An electric vehicle is environmentally advantageous due to its low emissions characteristics and general availability of electricity as a power source. However, battery storage capacity limits the performance of the electric vehicle relative to a comparable gasoline powered vehicle. Solar energy is readily available, but may not be sufficient by itself to operate the vehicle. Thus, there is a need in the art for a hybrid vehicle with an improved photovoltaic energy distribution system.

### SUMMARY

Accordingly, the present disclosure relates to a photovoltaic storage and charging system. The system includes a photovoltaic apparatus disposed on the vehicle for absorbing radiant energy and converting the absorbed radiant energy into electrical energy. At least one energy storage device stores the electrical energy from the photovoltaic apparatus, and the stored electrical power is available for use by the vehicle. An electrical energy converter is disposed between the photovoltaic apparatus and the energy storage device, to receive the electrical energy from the photovoltaic apparatus, boost the energy to a predetermined level for charging the energy storage device and deliver the boosted electrical energy to the energy storage device.

An advantage of the present disclosure is continuous charging of a vehicle's energy storage device utilizing solar power is provided. Yet another advantage of the present disclosure is more efficient vehicle operation through energy distribution between low and high voltage energy storage devices is available. Still yet another advantage of the present disclosure is the opportunity to deliver solar power to high voltage battery devices. A further advantage of the present disclosure is that the system communicates with and stores energy within an energy storage device such as a battery. Still a further advantage of the present disclosure is that the energy generated from the solar panel can be stored for later distribution. An advantage of the present disclosure is that the solar panel covers a large surface area of the vehicle to improve radiant energy absorption. Still yet another advantage of the present disclosure is that the solar panel is split into independent modules to maximize efficiency at different solar radiation angles and partial shading conditions with MPP tracking.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a vehicle having a photovoltaic system mounted on a roof of the vehicle.

FIG. 2 is a perspective view of a vehicle having a photovoltaic system mounted on a trunk of the vehicle.

FIG. 3 is a top perspective view of a solar panel for the vehicle.

FIG. 4 is a top view of the solar roof panel.

FIG. 5 is a detail drawing of the solar panel in exploded view.

FIG. 6 is detail view of adjacent solar cells connected.

FIG. 7 is a block diagram illustrating the solar charging system for the vehicle.

FIG. 8 is a block diagram illustrating a solar charging system for the vehicle.

FIG. 9 is a block diagram illustrating energy flow during low voltage charging and high voltage charging of the vehicle.

FIG. 10 is a diagrammatic view illustrating a low voltage battery charging system with a DC/DC converter for the vehicle.

FIG. 11 is a schematic flow diagram illustrating a low voltage charge distribution from a solar panel and energy distribution to vehicle components.

FIG. 12 is a schematic flow diagram illustrating low voltage charging to high voltage using a bidirectional DC/DC converter.

FIG. 13 is a graph showing an example of energy distribution as a function of time.

FIG. 14 is a schematic flow diagram illustrating energy distribution within a high voltage charging system.

FIG. 15 is a schematic flow diagram illustrating a high voltage charging system with energy flow path switches.

FIG. 16 is a schematic flow diagram illustrating a further example of low and high voltage charging with switches and a low voltage DC/DC converter and a bidirectional high voltage DC/DC converter.

### DESCRIPTION

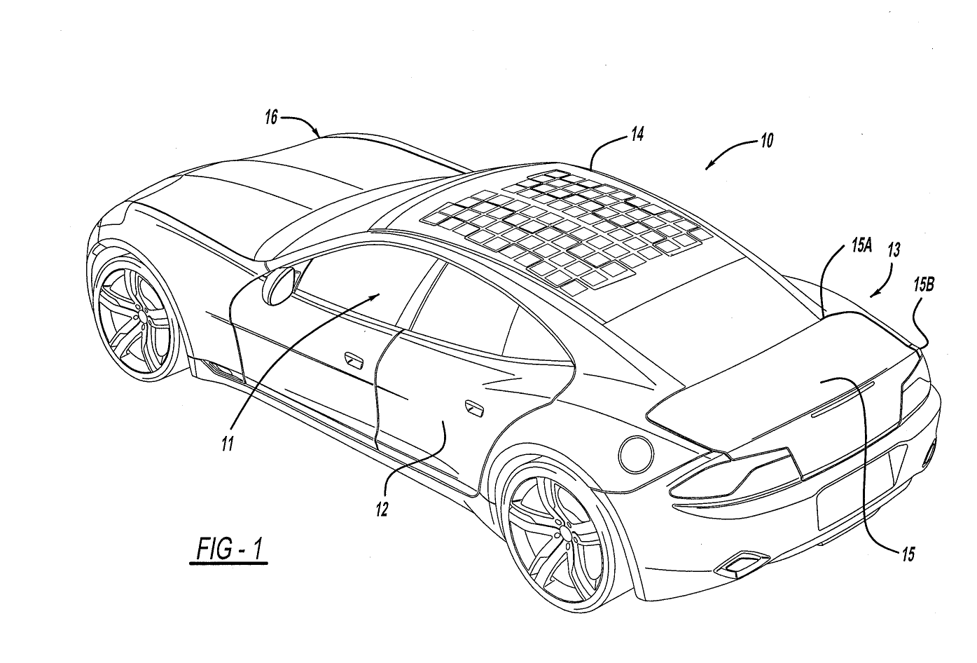

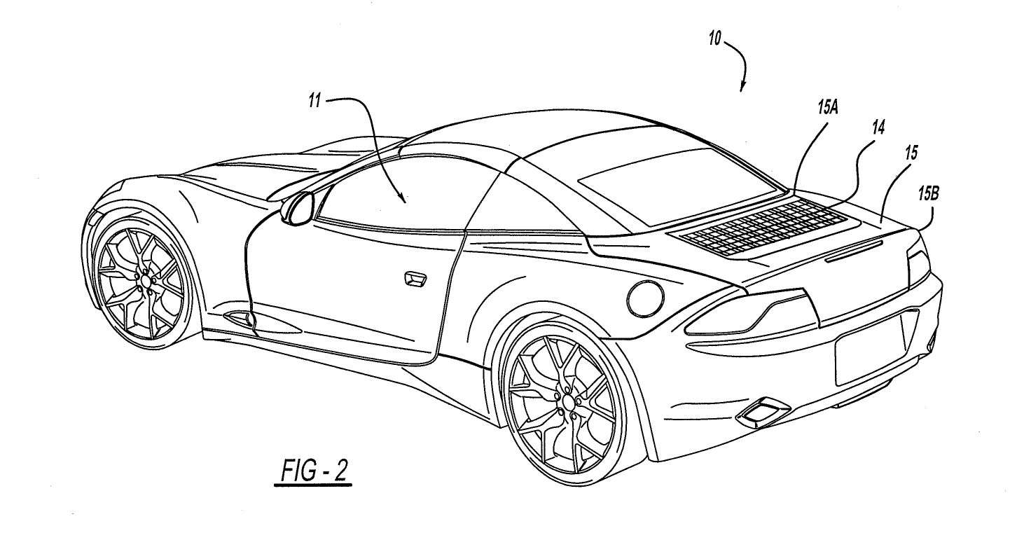

Referring to the FIGS. 1-2, a vehicle 10 having a solar panel 14 is illustrated. In this example the vehicle 10 is a plug-in hybrid vehicle that is both solar and electric powered. The vehicle 10 includes a body structure having a frame and outer panels 12 covering the frame that cooperatively form the shape of the vehicle. The vehicle 10 includes an interior space 11 referred to as a passenger compartment. For a convertible style vehicle 10, the passenger compartment 11 may be enclosed by a moveable convertible top that covers the passenger compartment 11 in an extended position. The vehicle 10 also includes a storage space 13 referred to as a trunk or luggage compartment 13. The trunk or luggage compartment 13 is accessible via a deck lid 15. The deck lid 15 is a panel member pivotally connected to the vehicle body, such that the deck lid 15 can articulate in multiple positions. For example, the deck lid 15 may pivot about a forward edge 15A in order to provide access to the trunk 13 of the vehicle 10, and a rearward edge 15B in order to stow the folded top within the vehicle trunk.

The vehicle 10 also includes a power train that is operable to propel the vehicle 10. In this example, the power train is a plug-in hybrid, and includes an electrically powered motor and motor controller. The vehicle 10 may also include a gasoline powered engine that supplements the electric motor when required under certain operating conditions. The electrical energy can be stored in an energy storage device, such as a battery, to be described. Various types of batteries are available, such as lead acid, or lithium-ion or the like. It should be appreciated that the vehicle 10 may include more than one type of battery or energy storage device. The battery supplies the power in the form of electricity to operate various vehicle components. In this example, there is a low voltage battery 70 that provides electrical power to vehicle components (e.g., a typical 12 V lead acid battery) and a high voltage battery 72 (e.g. over 60 V traction battery) and in this example a 400 V traction battery that provides electrical power to an electric drive motor. The batteries 70, 72 may be in communication with a control system that regulates the distribution of power within the vehicle 10, such as to the electric drive motor, or a vehicle component or other accessories or the like. In this example, the high voltage battery receives electrical energy from a plug-in source and a gasoline engine, and the low voltage battery 70 receives electrical energy from the high voltage battery or a photovoltaic source in a manner to be described. In a further example, the high voltage battery 72 and the low voltage battery 70 can receive electrical energy from a solar source.

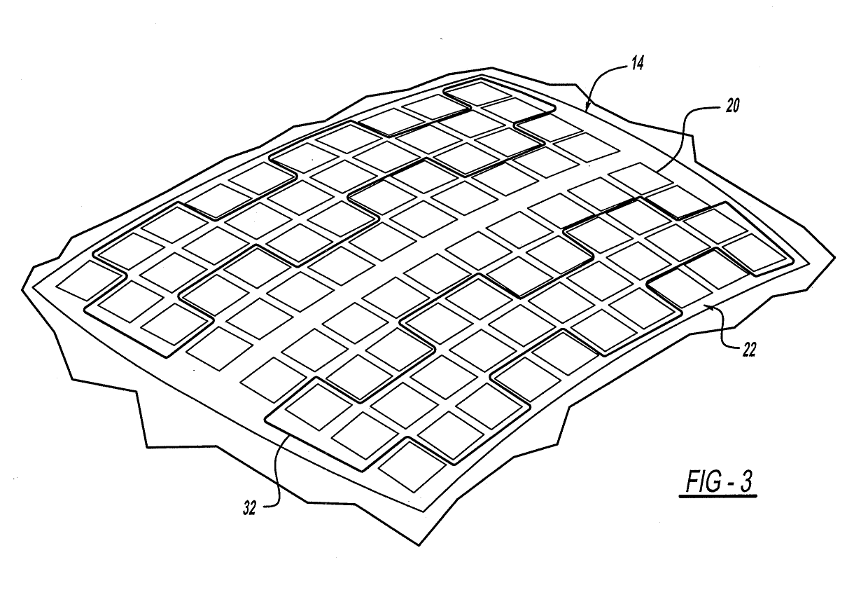

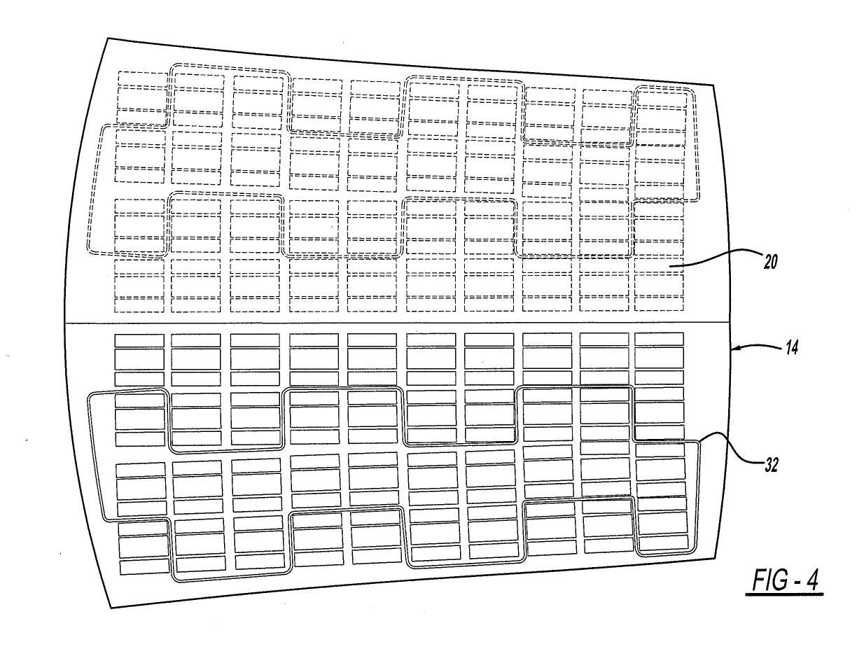

Referring to FIGS. 3-6, the vehicle includes a photovoltaic apparatus 14 that receives light energy and converts that energy to electrical energy. In an example, the photovoltaic apparatus is a generally planar solar panel 14 positioned on a surface of the vehicle 10, so as to receive radiant energy from the sun. The solar panel 14 is positioned to facilitate the collection of radiant energy, such as within a roof panel, deck lid 15 or another vehicle body panel 12. In an example, the solar panel 14 can define a generally planar geometry, a curvilinear geometry or otherwise corresponds to the contours of the vehicle outer panel 12. In a further example, to increase photovoltaic area, retractable solar panels may be provided that are operable to open and expose the solar panels to the sunlight.

The solar panel 14 is operable to collect radiant energy from the sun and convert the sun's energy into stored electrical energy that is available for use in the operation of the vehicle 10. The solar energy is available to supplement that of the other energy sources, such as a plug in source or fossil fuel of this example. The supplemental solar energy effectively increases the performance of the vehicle 10, i.e. increased electric range for use by another vehicle feature or accessory.

The solar panel 14 includes a plurality of solar cells 20 arranged in a solar array as shown in FIGS. 3, 4 and 7. In an example, the individual solar cells 20 may be encapsulated within a polymer layer 18. The solar cells 20 operatively convert absorbed sunlight into electricity. The cells 20 may be grouped and electrically connected and packaged together in a manner to be described. Generally, a solar cell 20 is made from a semiconductor material, such as silicon, silicone crystalline, gallium arsenic (GaAs) or the like. When the solar cell 20 receives the sunlight, a portion of the sunlight is absorbed within the semiconductor, and the absorbed light's energy is transferred to the semiconductor material. The energy from the sunlight frees electrons within the semiconductor material, referred to as free carriers. These free electrons can move to form electrical current, and the resulting free electron flow produces a field causing a voltage. Metal contacts are attached to the cell 20 to allow the current to be drawn off the cell and used elsewhere. The metal contacts may be arranged in a predetermined pattern in a manner to be described.

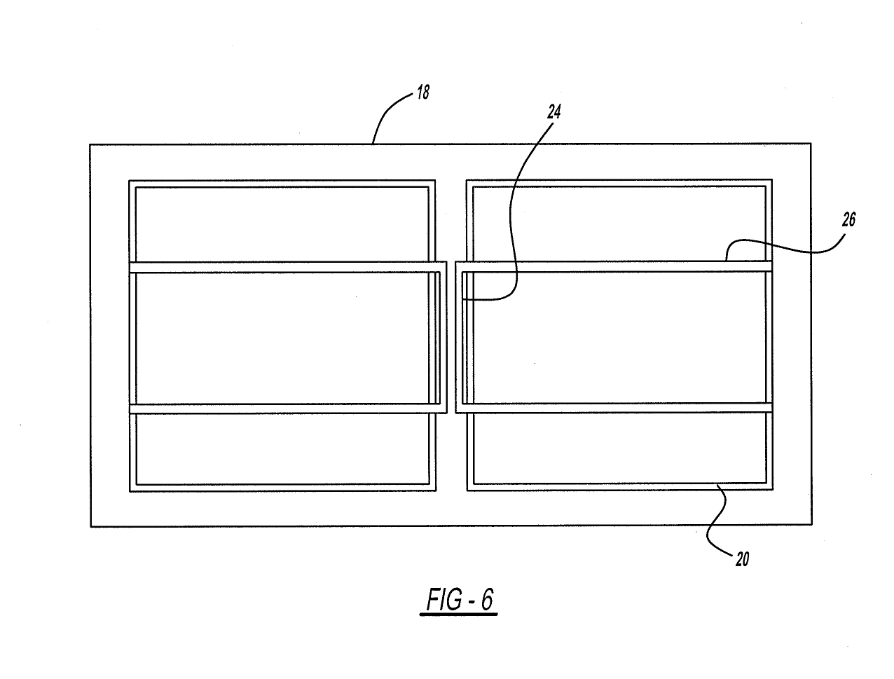

The solar panel 14 is divided into four sections or modules 22 that form electrically separate zones. The solar cells 20 are position within each module in a predetermined arrangement or pattern, such as an array. For example, each module may contains a 5 by 4 array of cells. The modules 22 themselves are connected by cross connector 24, or bus bars as shown in FIG. 6. Further, each cell 20 within a module is electrically connected in series by a cell connector 26 or stringer, as shown in FIG. 6. The dimension of each cell within the module and the corresponding array is sized to fill-up the available space. In a particular example, the array defines a partially and generally splayed pattern.

The solar panel 14 may be fabricated using various techniques, the selection of which is nonlimiting. In an example, the solar panel is fabricated from a glass panel having a laminate structure. In another example, the photovoltaic system can be mounted or incorporated within a composite structure, such as integrally formed within a polymer or composite material. The solar module may be laminated within a durable polymer, such as a scratch resistant polycarbonate. In a further example, the solar modules 22 are mounted in a thin film, such as amorphous silicon or the like. In an even further example, the photovoltaic system includes modules 22 that are formed in other exposed vehicle structures, such as in a window. An organic solar concentrators or specially dyed window may be used that channels light to solar cells at their edges. Accordingly, the solar panel structure will influence characteristics of the vehicle such as weight, cost, packaging or the like.

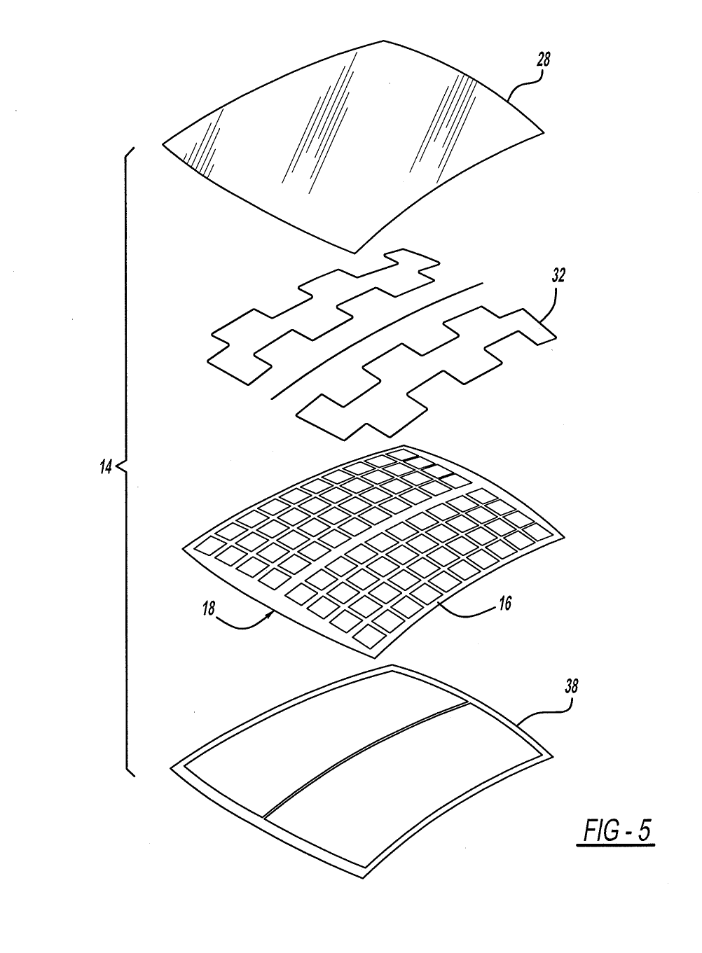

Referring to FIG. 5, an example of a laminate solar panel structure is illustrated. Accordingly, a first layer 16 may be a backing material, such as a foil material. A second layer 18 may be a polymer layer. An example of a polymer material is Ethylene Vinyl Acetate (EVA), or the like. A third layer may be a glass material. The solar cells 20 may be contained within a polymer material. The second layer 18 may include another layer of the polymer coating, thus sandwiching the solar cells 20 and connectors 24 and 26 between the polymer layers. In an example, the solar panel further includes a third or top layer 28 of glass (FIG. 5). This top layer 28 may include various coatings that may be decorative or functional in nature. For example, an inner surface of the top layer 28 can have an antireflective coating since silicon is a shiny material, and photons that are reflected cannot be used by the cell 20. In an example, the antireflective coating reduces the reflection of photons. The antireflective coating can be a black-out screen applied over all areas of the top layer except over the cells 20 that collect solar power. The antireflective coating may be black in color. For example, the black coating may be a material such as an acrylic or frit paint or the like. The top layer 28 may include additional graphic coatings 32 that visually enhance the appearance of the solar panel. In an example, an additional graphic pattern 32 may be applied to the top glass layer, such as by a paint or silk screening process. In a further example, the graphic pattern is in gold paint. The layers may be bonded together by the application of heat to the glass forming the layers together as a single unit.

The solar panel 14 is operatively in communication with a solar charging system 34. To maximize solar energy, and thereby offset fuel usage, the energy generated from the solar panel 14 is stored. Typically, the energy is stored in the low voltage battery 70. Further, the solar charging system 34 may operatively be in communication with a vehicle charging system in a manner to be described. Each of the modules 22 in the solar panel incorporate a maximum power point (MPP) tracking feature that maximizes power output for various solar radiation angles and partial shading conditions of the solar panel 14 in a manner to be described. This feature assumes that if one cell 20 in a particular module 22 is shaded from the sun, then the performance of other cells on the module can also be diminished. Since each module 22 is electrically separate and isolated from the other modules and thus independent, the energy collection operation of the other available modules 22 may be optimized.

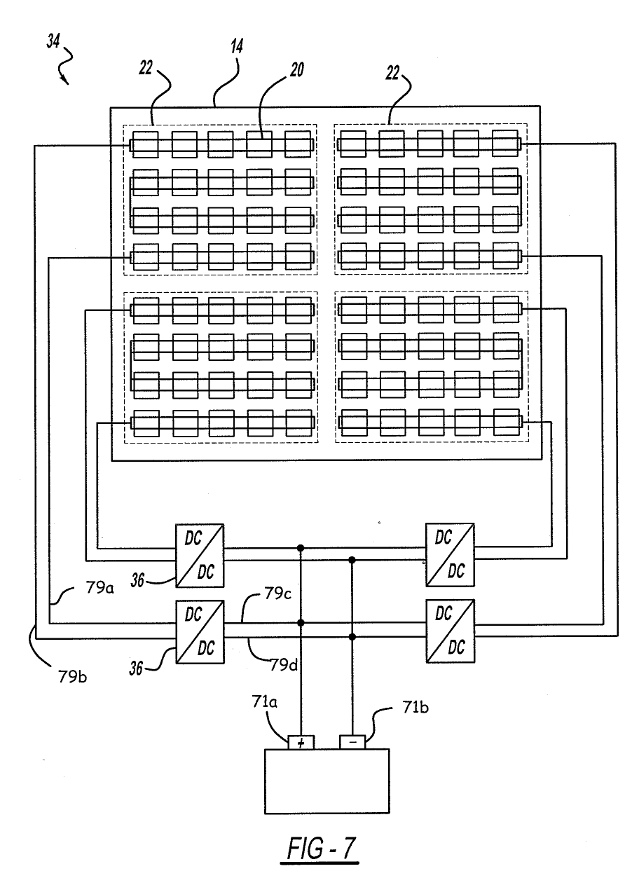

Referring to FIG. 7, the maximum power point tracking feature is described. The solar charging system 34 includes an electrical converter, such as a DC/DC boost converter 36, also referred to as a DC/DC converter, that is in communication with at least one of the solar panel modules 22, to adjust the module 22 output current. For example, each module 22 is coupled to a power booster or DC/DC converter 36 to adjust the voltage output from that module 22. The voltage from the modules 22 is lower than that which is needed to charge a low voltage battery 70. In this way, the output voltage of each module 22 is maintained and so the solar energy can be used to charge the low voltage battery 70. In an example, each solar panel module 22 can output up to 3 Amps, i.e. a total of 12 Amps for four modules 22. In this example, the power booster 36 is a DC/DC Energy Booster converter 36 that receives current from the solar module 22 and converts the voltage to a range usable by the vehicle. Typical ranges include 14-16 V for a low voltage battery, or about 216-422 V for a high voltage battery. In a further example, the module 22 output voltage is between 10-12 V and the DC/DC converter output is 14-16 V.

Each module 22 includes electrical lines that deliver the voltage to the converter 36. The energy storage device or battery 70 includes a positive terminal 71a and a negative terminal 71b. The voltage from the module 22 is delivered to the converter 36 through a positive voltage input line 79a and a negative voltage input line 79b. The output of the converter 36 includes a positive output voltage line 79c and a negative output voltage line 79d that correspond to positive terminal 71a and negative terminal 71b respectively.

Depending on the available sunlight with respect to the vehicle position, the solar modules 22, or photovoltaic modules, can experience partial or full shading. Shading of a single cell can cause performance of the corresponding module to decrease. For example, a 3% shading can cause a 25% reduction in power. To minimize partial shading losses, each module 22 is electrically isolated from the others. Each module 22 includes its own maximum power point (MPP) tracking. MPP is the point on the current-voltage (I-V) curve of a solar module 22 under illumination, where the product of current and voltage is maximum (Pₘₐₓ, measured in watts). The points on the I and V scales which describe this curve point are named Iₘₚ (current at maximum power) and Vₘₚ (voltage at maximum power).

If the solar panel has a compound curvature (i.e., curving in multiple directions as shown in FIG. 1), one corner of the roof will receive more radiation than another portion at various solar radiation angles. Thus, the cells 20 may be arranged within the module 22 to maximize radiation reception. Since the solar panel 14 is split into a plurality of modules 22, such as four in this example, partial shading conditions affecting only one module may be alleviated. For example, an object laying on the solar cell contained in one module 22 will not affect any other modules 22.

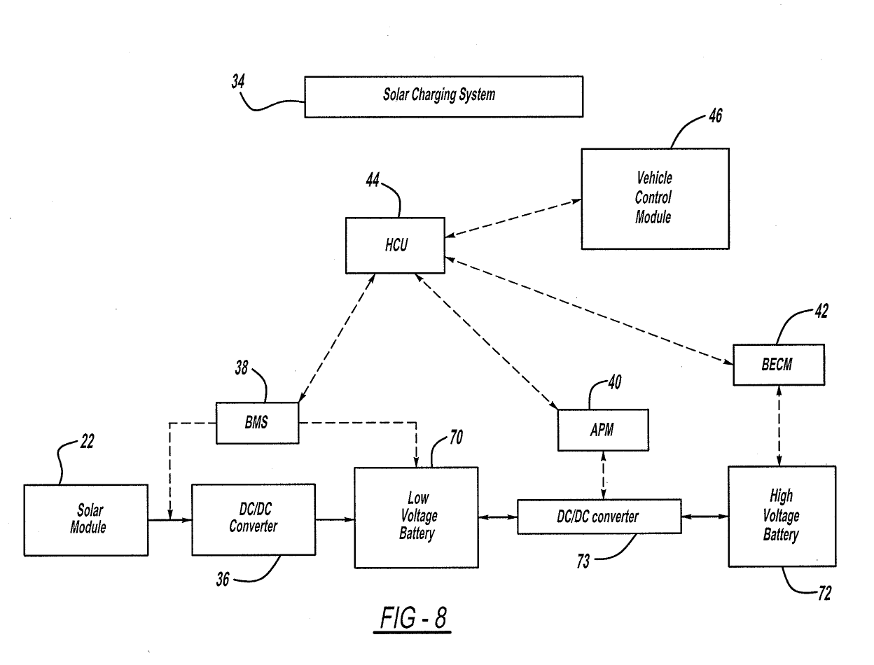

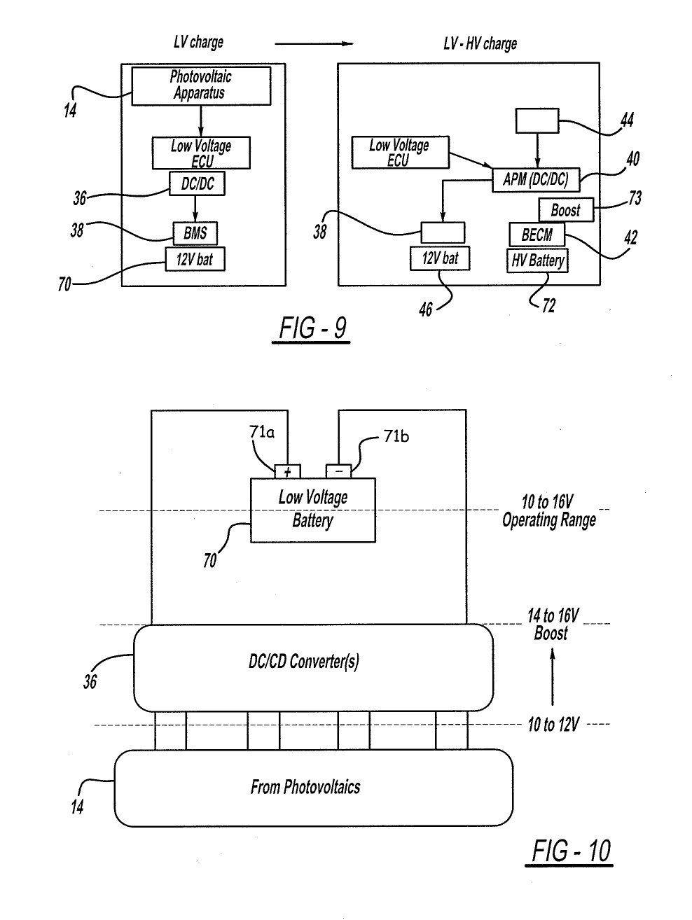

Referring to FIGS. 8 and 9, the solar charging system 34 can include a battery monitoring system (BMS) 38 that monitors the state of charge of the low voltage battery 70. In an example, the voltage of the low voltage battery varies between 8-16 V during typical vehicle operation. In a further example, the BMS 38 may also be used to monitor the amount of solar energy absorbed by the modules 22. Bi-directional energy flow capability can be employed between the low voltage battery 70 and a high voltage battery 72, depending on the charge state. BMS 38 can include electrical sensors that measure parameters of the battery 70 and the solar energy flow from the modules 22. BMS 38 can then be in communication with a hybrid control unit (HCU) 44 that receives the monitored data to potentially adjust vehicle performance. The HCU 44 can be programmed to adjust operation of various vehicle components to facilitate more efficient operation based on predetermined or preprogrammed parameters.

The solar charging system 34 can further include an accessory power module (APM) 40 that communicates with a DC/DC converter 73 to either boost or reduce voltage in the bidirectional energy flow between the low voltage battery 70 and a high voltage battery 72. For example, the DC/DC converter 73 used between a high voltage 72 and a low voltage battery 70 either boosts or reduces voltage depending on which direction the energy is flowing. The APM 40 monitors the energy flow to communicate with the solar charging system 34 to optimize energy distribution to the batteries 70 and 72.

The solar charging system 34 can further include a battery electronic control module (BECM) 42 that monitors the status and controls state of charge of the high voltage battery 72. It is understood, however, that the BECM 42 can be made to monitor the status and control states of charge for multiple energy storage devices, for example, the low voltage battery 70 and the high voltage battery 72. In a further example, alternative energy storage devices can be used such as a capacitor, multiple low voltage batteries, and the like. The solar charging system 34 includes a HCU 44, which is a controller that controls the high voltage contactors (not shown), such as the high voltage interlock. The HCU 44 may interface with other controllers, such as the vehicle control module (VCM) 46, APM 40, BMS 38, and/or BECM 42. The resulting charge is a steady state output. The VCM 46 manages the distribution of power between the photovoltaic apparatus 14, high voltage battery charging system, and electric motor.

Energy converted from the solar panel 14 can be used to charge the low voltage battery 70. Battery 70 can be used to further charge the high voltage battery. In an example, the low voltage battery is maintained below a predetermined threshold voltage in order to continuously receive energy form the solar panel 14. Accordingly, the vehicle 10 can be programmed to operate efficiently based on predetermined parameters and energy distribution between the photovoltaic apparatus 14, the low voltage battery 70, and the high voltage battery 72.

Referring to FIGS. 10-16, several examples of a charging system according to the present disclosure are shown. In an example, to enhance utilizing solar energy, and thereby offsetting, at least partially, fuel use, energy stored in a an energy storage device, such as a battery. The energy storage device can be a battery including but not limited to lead acid, lead foam, AGM, lithium ion, lithium air, and the like. Capacitors are another example of an energy storage device. The energy is generated from a photovoltaic system. As shown schematically in FIG. 10, photovoltaic system 14 delivers energy to a DC/DC converter or converters 36 which boosts the energy level (i.e., voltage) to accommodate a low voltage battery 70. The energy enters the battery through positive terminal 71a and negative terminal 71b.

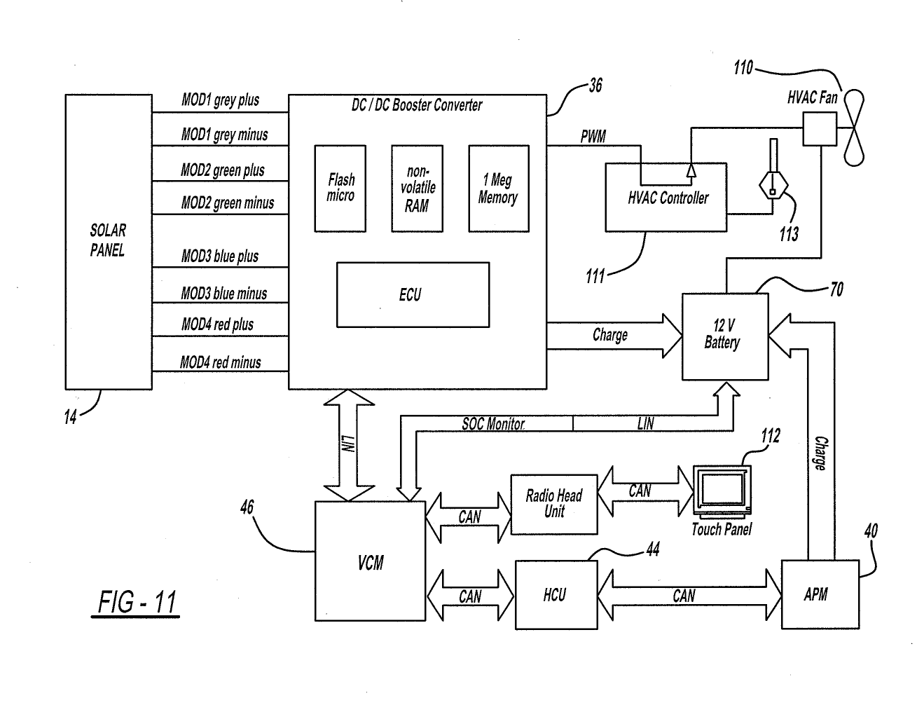

FIG. 11 illustrates an example of an electrical architecture including low voltage battery charging. Arrows represent direction of data transfer or energy flow as appropriate. In this architecture, the solar panel 14 is coupled to a boost converter 36 (part of an electronic control unit—ECU) which can power devices directly such as an heating, ventilation and air conditioning (HVAC) system fan 110. In an example it can charge a battery 70 which can then power devices such as fan 110. Fan 110 can be controlled by an HVAC controller 111. The solar panel 14 converts electromagnetic radiation (light) to electrical power (current and voltage). The boost converter 36 boosts the voltage output from the solar panel 14 to a level useful by the vehicle's low voltage systems.

In an example, a 12 V battery 70 is used as the low voltage battery 70. Battery 70 converts electrical energy to chemical potential energy for storage, and converts chemical potential energy to electric energy for use by devices. An example device, such as HVAC fan 110 uses electrical energy to serve various functions. The fan 110 can be powered by the boost converter 36 directly or by the 12V battery 70. In an example, controllers (VCM 46, HCU 44, APM 40, etc.) are used that communicate with various systems, store, and process data to control components. In a further example, a touch panel 112 is provided in the vehicle that allows users to interact with the photovoltaic system 14, e.g. to select how solar energy is used—for HVAC, charging, etc. It also displays information about the system's operation. Sensors, for example temperature sensor 113 connected to the HVAC controller 111, provide input to controllers to influence system operation. For example, in a certain mode, the vehicle may use solar power directly for ventilation rather than for charging if the cabin temperature rises above a threshold.

In an example, the low voltage battery 70 is depleted to a minimal acceptable state of charge (SOC) and caused to maintain that minimal level when the vehicle is on. This leaves more capacity to charge when the vehicle is off, thus increasing the utility of the photovoltaics and offsetting more fuel. If the battery 70 were maintained close to maximum SOC, the solar energy would only serve to maintain charge and not fully utilized for example with the high voltage battery 72.

In addition the high voltage battery 72 may be charged by the low voltage battery 70 which is continuously receiving energy from the photovoltaic apparatus 14. Generally, solar power is unlikely operable to maintain high voltage charging directly. Certain components like high voltage contactors may have a minimum threshold power to engage that the photovoltaic system 14 may not meet on its own. Accordingly, photovoltaics charge the low voltage battery continuously via DC/DC converter with MPP tracking until it reaches a threshold (such as almost full capacity), at which point the low voltage battery charges the high voltage battery via a boost converter at peak efficiency (relatively high power) until the low voltage battery reaches its minimum threshold, at which point high voltage charging ceases and low voltage photovoltaic charging continues. This process can repeat long as photovoltaic energy is available. Whereas a photovoltaic apparatus may only generate 130W, a low voltage battery 70 may be able to boost to high voltage at 600W via a boost converter 73 between the low voltage battery 70 and high voltage battery 72.

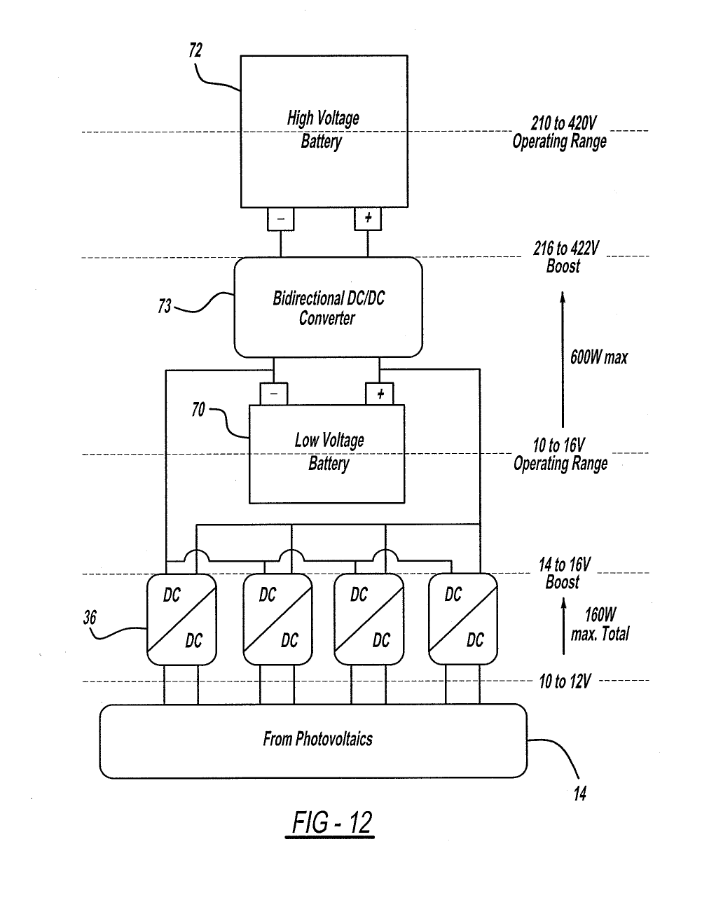

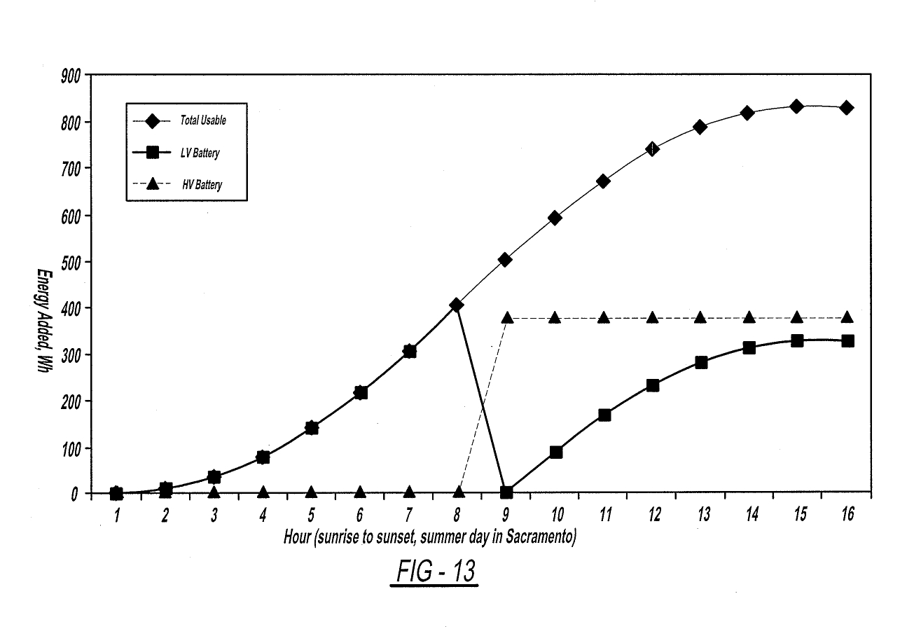

FIG. 12 is a further example of the charging system of FIG. 10. The arrows represent the direction of energy flow from photovoltaics 14. In this example, a plurality of converters 36 are used. A bidirectional DC/DC converter 73 serves primarily to power the low voltage systems of the vehicle and maintain charge in the low voltage battery 70 when the vehicle is powered on. It also serves to add energy to the high voltage battery 72 or high voltage system from the low voltage battery 70 for extreme conditions when the vehicle cannot start on high voltage battery 72 power alone. Bidirectional DC/DC converter 72, in a further example, can discharge energy from the low voltage battery 70 to the high voltage battery 72 whenever the low voltage battery 70 becomes fully charged from photovoltaic charging. Converter 72 can be operated close to its optimal efficiency point (higher power) to boost from the low voltage battery 70 to the high voltage battery 72 for short periods, see FIG. 13. In a further example, coverter 73 can be used as a dedicated boost converter. The high voltage battery 72 can convert energy between stored chemical energy and electrical energy. In an example, it powers high voltage systems of the vehicle, including the powertrain, HVAC systems, etc. FIG. 12 shows examples of energy operating ranges across each component. In an example, the high voltage battery 72 typically ranges from about 210 to 420 V, the boost from the bidirectional DC/DC converter 73 ranges from about 216 to 422 V; the operating range of the low voltage battery is from about 10 to 16 V over a power of up to about 600 W, the boost across low voltage DC/DC converters 36 is from about 14-16 V over a power of up to about 160 W, and the photovoltaic apparatus 14 operable to generate a voltage of 10 to 12 V.

FIG. 13 illustrates an example graph of measured energy stored using a low voltage to high voltage charging system of the present disclosure. Testing conditions to measure photovoltaic apparatus output power included irradiance level of 1000 W/m²; reference air mass of 1.5 solar spectral irradiance distribution; and cell or module junction temperature of 25° C. The energy added was made dependent on time on a summer day in a predetermined city, which in this example is Sacramento. At zero hours (sunrise), the vehicle starts with its low voltage battery at a defined minimal state of charge. During hours 1-8, the vehicle charges the low voltage battery from the photovoltaics as shown in FIGS. 9-11 and the high voltage battery system remains off. At hour 8, the low voltage battery reaches its maximum allowed state of charge, and then discharges to the high voltage battery via DC/DC boost conversion, as in FIG. 12. Energy gained from the photovoltaics boosts simultaneously with energy from the low voltage battery in this time period. This occurs at the system's peak efficiency point, which lies at a power higher than the photovoltaics can provide its own. Limiting the high voltage system to this time period increases its longevity. It may also increase safety in operating the high voltage battery. Hours 9-16, the vehicle continued to charge the LV battery, as in hours 1-8. Without the low voltage to high voltage charging capability, the system would not capture this energy, as the low voltage battery would remain relatively full. In an example, in an effort to increase safety, the low voltage to high voltage converter can be packed with the high voltage battery pack. This contributes to minimize the possibility of contact with the high voltage system during the high voltage start-up.

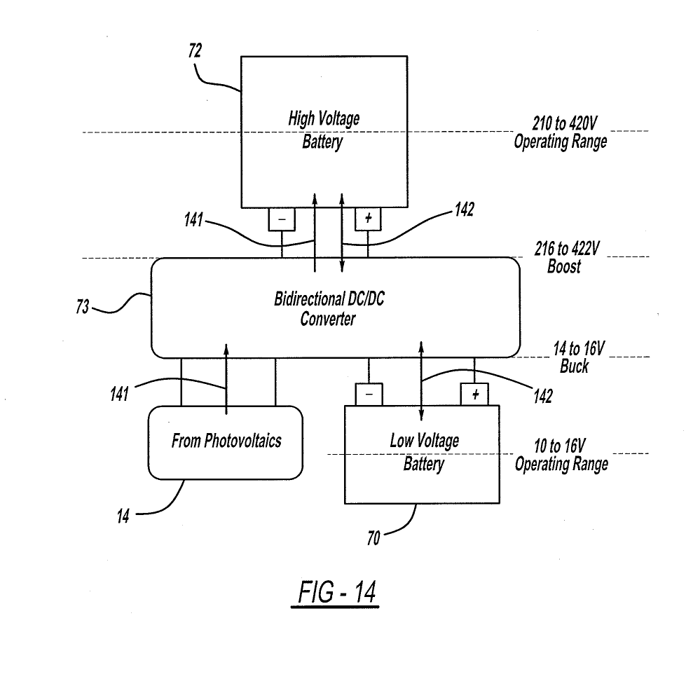

In an example, the high voltage battery is charged from the photovoltaic system via the bidirectional DC/DC converter as shown in FIG. 14. The DC/DC converter having MPP tracking can boost the energy from the photovoltaics' voltage level to the level that the high voltage battery requires for charging. Packaging the converter in the same box with the high voltage battery reduces high voltage exposure. Moreover, in an example, packaging the two together reduces the number of components, cost, and weight. A slight efficiency reduction may occur. The arrows show energy flow between the high voltage battery 72, bidirectional DC/DC converter 73, the photovoltaics 14, and the low voltage battery 70. FIG. 14 shows examples of energy voltage ranges of each component during normal operation. In an example, the high voltage battery 72 typically ranges from about 210 to 420 V, the boost from the bidirectional DC/DC converter 73 ranges from about 216 to 422 V; the operating range of the low voltage battery is from about 10 to 16 V, and the buck across DC/DC converters 73 to the low voltage battery 70 ranges from about 14-16 V.

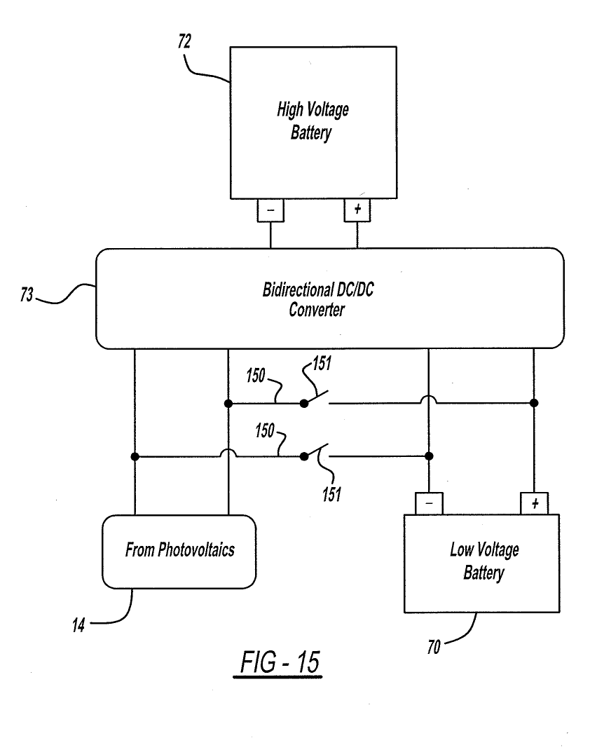

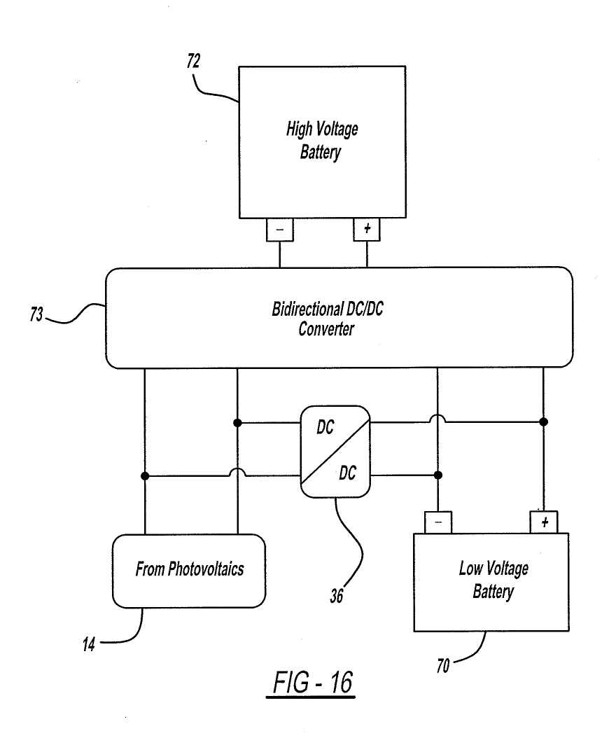

In an example, the bidirectional converter 73 typically does not boost and buck simultaneously. Accordingly, the solar panel 14 does not charge the high voltage battery 72 while the high voltage battery 72 powers low voltage components or when the low voltage battery 70 is charging. Accordingly energy paths 141 and 142 are mutually exclusive. For a system with a relatively small low voltage battery 70, this may mean that the system cannot capture solar energy while the vehicle is on. This would, however, only reduce the utility of the photovoltaic system marginally because often, solar charging occurs when the vehicle is parked. For a system with a normal or large low voltage battery 70, solar charging can still take place while the vehicle is on: Low voltage systems can run on energy stored in the low voltage battery 70, and the converter 73 can switch tasks to charge the low voltage battery periodically as necessary. In this scenario, the system only neglects potential solar energy when charging the low voltage battery 70. The system may include a direct connection to the low voltage bus 150 (no converter) from the photovoltaics 14, which the photovoltaic system 14 would switch to automatically when advantageous across switches 151. Accordingly, when voltage is sufficient to meet the requirements of the low voltage bus 150 (e.g. to charge the low voltage battery, as in FIG. 15 or to power low voltage devices), even without MPP tracking. Alternatively, the photovoltaics may connect directly to low voltage and high voltage converters. In this manner, the system can use nearly all available solar energy in various situations, and further take advantage of MPP tracking, as shown in FIG. 16.

The hybrid vehicle may include other features conventionally known for a vehicle, such as a gasoline motor, other controllers, a drive train or the like.

Many modifications and variations of the present disclosure are possible in light of the above teachings. Therefore, within the scope of the appended claim, the present disclosure may be practiced other than as specifically described.

What is claimed is:

1-15. (canceled)

16. A photovoltaic storage and charging system for a vehicle comprising:
a photovoltaic apparatus disposed on the vehicle for absorbing radiant energy and converting the absorbed radiant energy into electrical energy, wherein the photovoltaic apparatus includes a plurality of solar modules electrically isolated from each other, each solar module of the plurality of solar modules including a plurality of solar cells;
at least one energy storage device for storing the electrical energy from the photovoltaic apparatus and delivering stored electrical power for use by the vehicle; and
an electrical energy converter disposed between the photovoltaic apparatus and the energy storage device, wherein the converter is adapted to receive the electrical energy from the photovoltaic apparatus, boost the energy to a predetermined level for charging the energy storage device and delivering the boosted electrical energy to the energy storage device.

17. The system of claim 16, wherein the energy storage device is a low voltage battery.

18. The system of claim 16, wherein the electrical energy converter is a low voltage DC/DC boost converter.

19. The system of claim 17, further comprising a high voltage battery and a high voltage bidirectional DC/DC converter coupled to the high voltage battery and the low voltage battery, to control energy flow between the low voltage battery and the high voltage battery based on a state of charge of the low voltage battery.

20. The system of claim 19, wherein a battery monitoring system monitors the state of charge of the low voltage battery to first charge the low voltage battery using electrical energy from the photovoltaic apparatus and then charge the high voltage battery using electrical energy from the photovoltaic apparatus.

21. The system of claim 20, wherein the photovoltaic system is coupled to the high voltage bidirectional DC/DC converter to operatively charge the high voltage battery.

22. The system of claim 21, further comprising an auxiliary power module adapted to monitor energy flow and boost or reduce voltage in the bidirectional energy distribution between the low voltage battery and high voltage battery.

23. The system of claim 22, further comprising a battery electronic control module that monitors and controls a state of charge of the high voltage battery.

24. The system of claim 16, wherein the electric storage device is coupled to at least one auxiliary vehicle component.

25. A method of storing and distributing solar energy for a vehicle comprising:
collecting solar energy using a photovoltaic apparatus disposed on a vehicle, wherein the photovoltaic apparatus includes a plurality of solar modules electrically isolated from each other, and each solar module includes a plurality of solar cells, wherein the photovoltaic apparatus includes a plurality of solar modules electrically isolated from each other, each solar module of the plurality of solar modules including a plurality of solar cells;
converting the solar energy to electrical energy by the photovoltaic apparatus solar cells;
receiving the electrical energy from the photovoltaic apparatus by an electrical energy converter and boosting the electrical energy to a predetermined level for charging an energy storage device; and
delivering the boosted electrical energy to the energy storage device.

26. The method of claim 25, wherein the energy storage device is a low voltage battery.

27. The method of claim 26, further comprising controlling energy flow between the low voltage battery and a high voltage battery based on a state of charge of the low voltage battery via a high voltage bidirectional DC/DC converter coupled to the high voltage battery.

28. The method of claim 27, further comprising:
monitoring the state of charge of the low voltage battery; and
charging, based on the monitored state of charge, the low voltage battery using electrical energy from the photovoltaic apparatus and then charging the high voltage battery using electrical energy from the photovoltaic apparatus.

29. The method of claim 27, further comprising:
monitoring the energy flow; and
boosting or reducing, based on the monitored energy flow, voltage in the bidirectional energy distribution between the low voltage battery and high voltage battery using an auxiliary power module.

30. The method of claim 25, further comprising distributing the stored energy for use in operating the vehicle.

31. The method of claim 25, further comprising operating each solar module of the plurality of solar modules at its maximum power point.

32. The system of claim 16, wherein each solar module of the plurality of solar modules is operated at its maximum power point.

33. The system of claim 16, wherein the electrical energy converter comprises a plurality of electrical energy converters, each electrical energy converter for boosting energy received from a corresponding solar module of the plurality of solar modules.
